(19) United States
(12) Patent Application Publication
(10) Pub. No.: US 2026/0031620 A1
(43) Pub. Date: Jan. 29, 2026

(54) CONVERTER AND METHOD FOR OPERATING A DC SUPPLY NETWORK

(71) Applicant: SMA Solar Technology AG, Niestetal (DE)

(72) Inventors: Alexander Unru, Baunatal (DE); Michael Schreck, Volkenschwand (DE); Josef Höflsauer, Volkenschwand (DE); Marcel Kratochvil, Kassel (DE)

(21) Appl. No.: 19/345,144

(22) Filed: Sep. 30, 2025

Related U.S. Application Data
(63) Continuation of application No. PCT/EP2024/062169, filed on May 3, 2024.

(30) Foreign Application Priority Data
May 5, 2023 (DE) 10 2023 111 797.1

(51) Int. Cl. H02J 3/00; H02J 3/32; H02J 3/38; H02M 1/00; H02M 1/36

(52) U.S. Cl. CPC H02J 3/0012; H02J 3/32; H02J 3/381; H02M 1/0009; H02M 1/36; H02J 2300/24

(57) ABSTRACT

The disclosure relates to a method for operating a DC supply network which is connected to an AC supply network via an active AC/DC converter and a star-point-grounded transformer. At least one disconnecting element is arranged between the AC supply network and the transformer and at least one device for supplying direct current independently of the AC supply network is provided in the DC supply network. The method includes stopping the conversion of alternating current to direct current, disconnecting the transformer from the AC supply network, supplying power to the DC supply network, and operating the converter to convert direct current to alternating current and applying AC voltage to at least two secondary windings of the transformer.

### REFERENCE TO RELATED APPLICATIONS

This application is a Continuation of International Application number PCT/EP2024/062169, filed on May 3, 2024, which claims the benefit of German Application number 10 2023 111 797.1, filed on May 5, 2023. The contents of the above-referenced patent applications are hereby incorporated by reference in their entirety.

### FIELD

The disclosure relates to a method for operating a DC supply network which is connected to an AC supply network via an active AC/DC converter and a star-point-grounded transformer, at least one disconnecting element being arranged between the AC supply network and the transformer and at least one device for supplying direct current independently of the AC supply network being present in the DC supply network. The disclosure further relates to an active AC/DC converter which is configured to perform the method.

### BACKGROUND

In industrial plants, DC power supply networks are increasingly being used to supply energy to components of the industrial plant. DC supply networks offer the advantage that energy storage devices that buffer peak loads in the network are easier to integrate, as are renewable energy generation systems, such as photovoltaic systems. In addition, DC converters, which reduce the usually higher voltage of the DC power supply network to an operating voltage of the component, can be implemented in the individual components with less effort and space than AC/DC converters (“power supplies”), which are arranged in each component or multiple times in each control cabinet. The efficiency of DC converters is also higher compared to power supplies.

### SUMMARY

To feed power into the DC supply network, a star-point-grounded transformer is usually provided, which is connected on the primary side to a low-voltage or medium-voltage network. In Europe, TN networks are usually implemented by grounding the transformer star point.

When the DC supply network is fed via the converter, the ground potential is transferred to the DC voltage side by the clocking of the converter's switching elements. The DC voltage network then has potentials on its two power supply lines, which potentials are symmetrical with respect to the ground potential. Compared to a DC supply network, in which one of the two supply lines is connected to ground potential, this offers the advantage that the maximum voltage between the ground potential and a line of the DC supply network is lower, specifically half as large. Accordingly, the requirements regarding insulation strength in DC supply networks are reduced.

If the AC supply network fails, alternative power sources are available in the DC supply network of the type mentioned at the outset, in order to be able to bridge the power failure at least temporarily and to ensure that the components of the industrial plant can be shut down to a safe state before they are no longer supplied with power. Such alternative power supply sources are, for example, renewable power generation plants, generators and/or energy storage devices.

However, the problem arises in this case that the reference to the ground potential in the DC supply network is no longer present because the converter that established this ground reference is no longer in operation. The DC supply network thus becomes an isolated network that no longer has a secure ground connection. The existing protection concept is no longer sufficient for this emerging isolated network form, which makes protection concepts necessary. For example, insulation monitors may be necessary at various points in the DC supply network.

It is an object of the present disclosure to provide a method for operating a DC supply network of the type described at the outset, in which secure operation without additional protection concepts is possible even in the event of a failure of the AC supply network and a disconnection from this AC supply network.

A method according to the disclosure for operating a DC supply network comprises:
conversion of alternating current to direct current by the converter being stopped and the transformer being disconnected from the AC supply network, for example, after detection of a fault in the AC supply network, e.g. a failure of at least one phase of the AC supply network.

The DC supply network is then supplied by the at least one device for supplying DC current and the converter is operated to convert DC current to AC current and applies AC voltage to at least two secondary windings of the transformer. In one embodiment, all secondary windings of the transformer are supplied with alternating voltage.

By applying alternating voltage from the DC supply network to the at least two secondary windings of the transformer through the converter, the DC supply network and the transformer are re-coupled, which also re-establishes a ground reference of the DC supply network via the star point of the transformer. The temporarily isolated DC supply network becomes a TN network with ground reference again. In one embodiment, the center potential between lines of the DC supply network is brought to ground potential, so that the potentials of the DC lines are symmetrical around the star point of the transformer and thus symmetrical around the ground potential. In this way, it is achieved that even in this mode of operation a maximum potential difference between the DC lines and the ground potential is only half as large as the voltage level between the DC lines, i.e. the voltage level in the DC supply network. The insulation requirements in the DC supply network therefore do not increase.

In an advantageous embodiment of the method, the converter is operated in a voltage-regulating manner to apply alternating voltage to the at least two secondary windings of the transformer, a phase offset between the alternating voltages applied to the secondary windings being suitably selected in order to ensure that the potentials of the DC lines are as constant as possible with respect to the ground reference defined by the star point. For two secondary windings supplied with alternating voltage, a phase offset of 180° can be selected; for three secondary windings supplied with alternating voltage, a phase offset of 120° can be selected. In one embodiment, the at least two secondary windings of the transformer are supplied by the converter with a voltage whose amplitude is smaller than a minimum permissible secondary voltage in normal operation of the AC supply network and particularly preferably is smaller than approximately 50 volts (V). It has been shown that voltages in the range of 10 V to several 10 V on the secondary side of the transformer are sufficient to establish the ground reference in the DC voltage network. In this way, magnetization losses in the transformer are kept as low as possible.

In a further advantageous embodiment of the method, the converter outputs a status signal which indicates the operation for applying alternating voltage to the at least one secondary winding of the transformer. Consumers in the DC supply network can respond to this signal and adjust their operating mode depending on the status signal, e.g. switch to an operating mode that requires less power.

In a further advantageous embodiment of the method, a fault current detector arranged on the AC side is operated, which emits a signal by which the DC supply network is taken out of operation when a fault current on the AC side is detected. By coupling the networks via the converter, a fault current detector that may already be present on the AC side can advantageously be used to detect insulation problems in the DC voltage network. In order to cease operation of the DC supply network, the operation of at least one device for supplying DC current can, for example, be stopped in response to a detected fault current. In addition, a discharge device can be activated to reduce a voltage in the DC supply network, which further increases operational reliability. It may be provided in this case to set fault current limits on the fault current detector that differ from the fault current limits that are set on the fault current detector in normal operation, in order to be able to use it optimally for the detection of insulation faults in the DC supply network.

A converter according to the disclosure for converting alternating current to direct current comprises a device for monitoring a connection to an AC supply network via a transformer. The converter is configured to convert direct current to alternating current and to switch to voltage-regulating operation when the device detects a disconnection from the AC supply network. With a converter, the previously specified method can be carried out with its advantages.

In one embodiment, the converter is configured to generate an alternating voltage whose amplitude is smaller than a minimum permissible secondary voltage in normal operation of the AC supply network and in particular is smaller than approximately 50 V. In another embodiment, the converter comprises an AC-side fault current detector configured to output a signal upon detection of an AC-side fault current, which signal is made available to external components. The advantages already mentioned in connection with the method arise in each case.

### BRIEF DESCRIPTION OF THE FIGURES

The disclosure is explained in more detail below on the basis of an embodiment with the aid of figures. In the figures:

FIG. 1 is a schematic block diagram of a DC supply network connected to an AC supply network; and

FIG. 2 is a flowchart of a method for operating a DC supply network.

### DETAILED DESCRIPTION

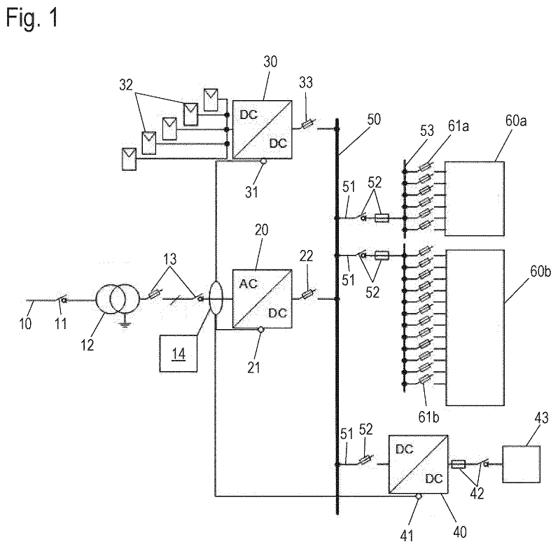

FIG. 1 is a schematic block diagram of a DC supply network 50 coupled to an AC supply network 10. The DC supply network 50 is also referred to below, for short, as DC (direct current) network 50. The AC supply network 10 is accordingly also referred to as AC (alternating current) network 10.

In order to couple the DC network 50 to the AC network 10, a transformer 12 is provided which is connected to the AC network 10 via a disconnecting element 11. Depending on the power to be made available in the DC network 50 and depending on availability, the AC network 10 can be a medium-voltage network and, accordingly, the transformer 12 can be a medium-voltage transformer and the disconnecting element 11 can be a medium-voltage switching or disconnecting element. Alternatively, the AC network 10 can also be a low-voltage network.

For the required power levels, the AC network 10 will typically be a three-phase network and the transformer 12 will accordingly be a three-phase transformer having at least three secondary windings connected to one another in a node, which is also called the “star point” of the transformer 12. In the system shown in FIG. 1, the star point of the transformer 12 is connected to a ground point so that the star point of the transformer 12 is at ground potential. This creates the TN network that is common in many parts of Europe, i.e. a network type in which the AC low-voltage network is grounded in the vicinity of the building installation. However, it is also conceivable that the transformer 12 has only two secondary windings that are connected to each other in a node and grounded there. In this case, a so-called split-phase network is created. The method is also applicable in such a configuration.

The transformer 12 is connected via at least one switching and/or safety device 13 and a fault current detector 14 to an active alternating current-to-direct current converter 20, hereinafter also abbreviated as AC/DC converter 20.

This AC/DC converter 20 functions as an active rectifier in normal operation, in which the DC network 50 is primarily supplied from the AC network 10. It correspondingly has actively switched switching elements within converter bridge branches. Compared to passive rectifiers, losses can be minimized in this way and the generated DC voltage can be regulated, the output potentials on DC voltage output lines (DC lines) of the DC network 50 being able to be adjusted so that their potentials are symmetrical around the star point of the transformer 12 and thus symmetrical with respect to the ground potential. In this way, it is achieved that a maximum potential difference between the DC lines and the ground potential is only half as large as the voltage level between the DC lines, i.e. the voltage level in the DC network 50. As a result, for example, the insulation requirements in the DC network 50 are reduced.

The AC/DC converter 20 is connected to this DC network 50 via at least one switching and/or safety device 22. In addition, the AC/DC converter 20 has an emergency stop input 21 coupled to the fault current detector 14 in order to enter a safe operating state when fault currents occur in the AC network 10 and to disconnect the DC network 50 from the AC network 10.

A DC converter 30, hereinafter also referred to as DC/DC converter 30, is provided as a further energy source feeding into the DC network 50, is the DC/DC converter 30 being connected on the input side to a photovoltaic generator (PV generator) 32. The PV generator 32 is symbolically represented by a plurality of individual PV cells. In one implementation of the arrangement shown, the PV generator 32 may consist of a plurality of PV modules connected in series and/or parallel. It is understood that further comparable DC/DC converters coupled to PV generators may be coupled to the DC network 50. In turn, at least one switching and/or safety device 33 is provided for the connection between the illustrated DC/DC converter 30 and the DC network 50. In a manner comparable to the AC/DC converter 20, the DC/DC converter 30 also has an emergency stop input 31 coupled to the fault current detector 14 in order to be able to bring it into a safe operating state in the event of fault currents occurring.

As a further energy source, for example, for emergency power supply, there is a further direct current converter 40, hereinafter also referred to as DC/DC converter 40, connected via at least one switching and/or safety element 42 to an energy storage device 43, for example, a storage battery. This additional DC/DC converter 40 also has an emergency stop input 41 which, like the converters 20, 30, is coupled to the fault current detector 14, the DC/DC converter 40 being controlled by the emergency stop input 41 in order to assume a safe operating state in the event of a fault.

Two consumer arrangements 60a, 60b are shown by way of example, each having a plurality of components operated with direct current. They are connected to the DC network 50 via distribution panels 53, wherein separate safety and/or switching devices 61a, 61b are arranged upstream of each component or group of components. The distribution panels 53 are supplied with direct current via branches 51 of the DC network 50 and associated additional safety and/or switching devices 52.

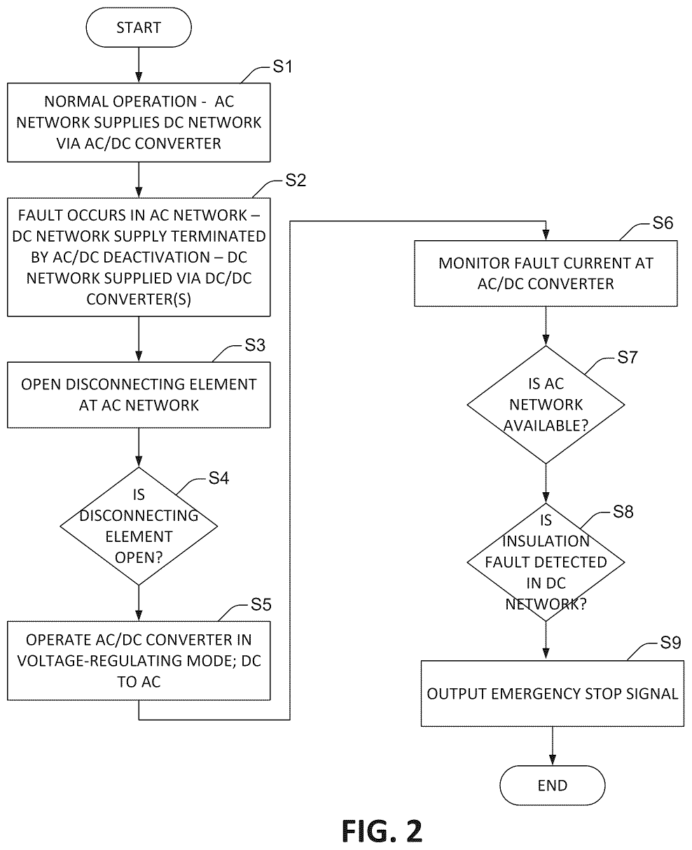

A method according to the disclosure for operating a direct current supply network, for example the direct current supply network 50 shown in FIG. 1, is explained in more detail below with reference to FIG. 2. FIG. 2 shows a schematic flow diagram of an embodiment of the method, explained by way of example with reference to the arrangement according to FIG. 1.

The method starts at act S1 in which the arrangement is operated in a normal operating state. In this context, normal operation means that all phases of the AC network 10 are present and the AC network 10 supplies the AC/DC converter 20 with alternating current via the transformer 12 and the intermediate disconnecting or switching and safety devices 11, 13. The AC/DC converter 20 converts the alternating current to direct current and feeds it into the DC network 50, from which the consumer arrangements 60a, 60b are supplied. Additional current sources, such as the photovoltaic generator 32 with the DC/DC converter 30, can feed into the DC network 50 in a supporting manner. If the current sources feed more power into the DC network 50 than the consumer arrangements 60a, 60b require, the AC/DC converter 20 can also be operated bidirectionally and feed the excess power back into the AC network 10. However, the excess energy can also be fed to the energy storage device 43, or the current sources can be regulated to such an extent that no excess energy is produced.

At act S2, a fault occurs in the AC network 10, which is detected by voltage monitors arranged on the input side of the AC/DC converter 20 or connected upstream of it. The fault may affect one or more phases of AC network 10. After the fault is detected, the AC/DC converter 20 enters a fault operating state in which it stops the clocking of its switching elements and thus terminates the supply of the DC network 50.

The DC network 50 is then further supplied by the DC converter 30 of the PV system and/or the further DC converter 40 which is coupled to the DC energy storage device 43.

In response to the detected fault in the AC network 10, the disconnecting element 11 opens at act S3, which is usually controlled by a fault detection circuit independent of the AC/DC converter 20.

In a subsequent act S4, the AC/DC converter 20 queries whether the disconnecting element 11 is open. If this is not the case (N), the AC/DC converter 20 remains in the fault operating state. It may be provided that the query at act S4 is carried out repeatedly until it is determined that the disconnecting element 11 is open (Y). The method is then continued at act S5.

At act S5, the AC/DC converter 20 is operated in a voltage-regulating manner so that the direct voltage of the DC network 50 is converted into alternating voltage, which is then applied to the secondary side of the transformer 12. This restores a potential coupling between the DC network 50 and the transformer 12, so that a ground reference of the DC network 50 via the star point of the transformer 12 is also re-established. The DC network 50, which was operated in isolation for a short time, becomes a TN network with a ground reference, in which the center potential between the DC lines of the DC network 50 is at ground potential.

In this case, the AC/DC converter 20 is operated in a voltage-regulating manner, i.e. it applies a predetermined voltage amplitude to the secondary windings of the transformer 12. In this voltage-regulating operation, the voltage amplitude is, for example, smaller than the minimum permissible secondary-side operating voltage of the transformer 12 during normal operation. In this way, magnetization losses in the transformer 12 are reduced.

In one embodiment, a value is set which is less than 50% of the minimum permissible secondary-side operating voltage of the transformer 12 in normal operation and, for example, a value is selected which is less than approximately 50 V.

In a subsequent act S6, the fault current detector 14 is used to monitor a fault current caused by the voltage-regulating operation of the converter 20. In this case, the fault current detector 14 is capable of detecting DC-side fault currents. In one embodiment, it may be provided that fault current limit values are selected for the voltage-regulating operation of the AC/DC converter 20 which differ from those of normal operation. It may also be provided to take into account both AC voltage components of the fault current and DC current components of the fault current in the voltage-regulating operation of the AC/DC converter 20. The fault current detector 14 is, in one embodiment, connected on the AC side of the converter 20, but can also be connected on the DC side.

Subsequently, the AC/DC converter 20 remains in voltage-regulating operation as long as the AC network 10 is still unavailable. This is monitored at act S7. If the AC network 10 is available again (Y), normal operation is restored and the method branches back to act S1.

For this purpose, the AC/DC converter 20 is stopped and the disconnecting element 11 is switched on again at act 7a. The AC/DC converter 20 can then resume its normal operation.

In addition to the check at act S7 as to whether the AC network 10 is available again, in a further act S8 a check is made as to whether the fault current detector 14 detects an insulation fault in the DC network 50. If not (N), the AC/DC converter 20 remains in voltage-regulating mode, so that the DC network 50 can continue to be operated as a TN network as long as the PV generators 32 or the energy storage device 43 can supply the consumer arrangements 60a, 60b.

If it is determined at act S8 that the fault current detector 14 has triggered (Y), in a subsequent act S9 an emergency stop signal is output to the connected devices, in this case to the AC/DC converter 20 and the DC/DC converters 30 and 40, which then stop their operation. In this case, it can be provided that a signal for shutting down the consumer arrangements 60a, 60b is issued beforehand in order to enable their components to safely terminate their operation beforehand.

It can be provided that the emergency signal is only issued in voltage-regulating operation, not in normal operation or only after a specified delay time. This can have the advantage that in normal operation, in the event of a fault current, the fault current that occurs can be used to trigger a fuse and thus to locate the fault location. In some cases, the DC network 50 can continue to be operated because the insulation fault has been removed by the fuse tripping.

As an additional safety measure, a discharge device, which may be present in the DC network 50, can also be activated in this case (at act S9), in order to bring the voltage in the network to a safe value, e.g. less than 50 V, as quickly as possible.

What is claimed is:

1. A method for operating a DC supply network connected to an AC supply network via an active AC/DC converter and a star-point-grounded transformer, at least one disconnecting element being arranged between the AC supply network and the star-point-grounded transformer and at least one device for supplying direct current independently of the AC supply network being provided in the DC supply network, comprising:
stopping a conversion of alternating current to direct current by the active AC/DC converter;
opening the disconnecting element to disconnect the star-point-grounded transformer from the AC supply network;
supplying the DC supply network by the at least one device for supplying direct current; and
operating the active AC/DC converter in a voltage-regulating mode and applying alternating voltage to at least two secondary windings of the transformer.

2. The method according to claim 1, wherein the at least two secondary windings of the transformer are supplied by the active AC/DC converter with a voltage having an amplitude that is smaller than a minimum permissible secondary voltage in a normal operation of the AC power supply network.

3. The method according to claim 2, wherein the voltage amplitude is less than about 50 volts.

4. The method according to claim 1, wherein the method is carried out after a failure of at least one phase of the AC power supply network.

5. The method according to claim 1, further comprising outputting a status signal by the active AC/DC converter, wherein the status signal indicates an operation for applying alternating voltage to at least one of the at least two secondary windings of the transformer.

6. The method according to claim 5, wherein consumers in the DC supply network adjust their operating mode depending on the status signal.

7. The method according to claim 1, wherein in the voltage-regulating mode, further comprising monitoring the active AC/DC converter for an occurring fault current using a fault current detector and, upon detection of a fault current, outputting a signal by which the DC supply network ceases operation.

8. The method according to claim 7, wherein the fault current detector monitors for the fault current on an AC side of the active AC/DC converter.

9. The method according to claim 7, wherein in order to cease operation of the DC supply network, an operation of the at least one device for supplying direct current is stopped.

10. The method according to claim 9, further comprising activating a discharge device in order to reduce a voltage in the DC supply network.

11. The method according to claim 8, further comprising setting fault current limits on the fault current detector in the voltage-regulating operation, wherein the fault current limits in the voltage-regulating operation differ from fault current limits set on the fault current detector in a normal operation.

12. A converter configured to convert alternating current to direct current, comprising a monitoring device configured to monitor a connection to an AC supply network via a transformer, wherein
the converter is configured to convert direct current to alternating current and to switch to a voltage-regulating operation when the monitoring device detects a disconnection from the AC supply network.

13. The converter according to claim 12, wherein the converter is further configured to generate an alternating voltage having an amplitude that is smaller than a minimum permissible secondary voltage in a normal operation of the AC supply network.

14. The converter according to claim 12, further comprising an AC-side fault current detector configured to output a signal upon detection of an AC-side fault current, wherein the signal is output to external components.
